(19) United States
(12) Patent Application Publication
(10) Pub. No.: US 2014/0244582 A1
(43) Pub. Date: Aug. 28, 2014

(54) Apparatus and Methods for Selective Location and Duplication of Relevant Data

(71) Applicant: Jonathan GRIER, Lakewood, NJ (US)

(72) Inventor: Jonathan GRIER, Lakewood, NJ (US)

(21) Appl. No.: 14/059,410

(22) Filed: Oct. 21, 2013

Related U.S. Application Data
(60) Provisional application No. 61/769,606, filed on Feb. 26, 2013.

(51) Int. Cl. G06F 17/30

(52) U.S. Cl. CPC G06F 17/30575
USPC 707/624

(57) ABSTRACT

Apparatus and methods are provided for performing a digital forensic investigation. Aspects of the apparatus and methods determine the location of forensically relevant data on a data source and copy this relevant data to a storage device in a forensically sound manner. Information related to the location of the relevant data may also be stored on the storage device.

### CROSS REFERENCE TO RELATED APPLICATIONS

This application claims the benefit of the filing date of U.S. provisional patent application No. 61/769,606 entitled “Apparatus and Methods for Selective Location and Duplication of Relevant Data”, which was filed on Feb. 26, 2013, by the same inventor of this application. That provisional application is hereby incorporated by reference as if fully set forth herein.

### FIELD OF THE INVENTION

The invention relates generally to copying of electronic files and more particularly to apparatus and methods for selectively locating and replicating, in a forensically sound manner, relevant data from a data source.

### BACKGROUND OF THE INVENTION

A digital forensic investigation is an investigation of a digital source such as a computer, computer peripheral, video camera, still camera, smartphone, network, network device, hard-drive, floppy disk, CD, DVD), nonvolatile memory (Flash, USB drive, thumb drive, built-in Flash), volatile memory (RAM), etc. to determine the state of and/or events related to the data, using procedures and techniques which allow the results to be entered into evidence in a court of law. Typical applications of digital forensic investigations include law enforcement investigations, electronic discovery (e-discovery) in civil cases, incident responses such as to data theft, etc.

A digital forensic investigation typically begins with receipt of an assignment and a determination of which data/information the investigator is being charged with finding. In other words, the investigator is informed and/or can determine from experience what information will be “relevant” to an investigation. Since different investigations may have different objectives and/or requirements, information that is relevant in one investigation may or may not be relevant in another investigation. Relevance is thus specific to an investigation. Relevance may also be a relative concept such that data may fall within a range somewhere between completely irrelevant and very relevant to a specific issue or sub-issue.

The next step in a conventional digital forensic investigation is imaging: the investigator makes a bit-for-bit copy of the entire data source (including relevant, irrelevant and empty data) in a forensically sound manner. The image is guaranteed to be an identical duplicate, without modification, of the original system, in a form which can be analyzed and investigated. Conventional imaging is done using existing, specialized hardware and software (e.g. forensic duplicators, forensic bridges, forensic write blockers and imaging software).

Recent technology trends have caused a surge in the number and capacity of data sources, however, the speed of these devices has not kept pace with the increased capacity. As a consequence of this imbalance, the amount of time required to create a forensic image has been growing to a point where it is becoming impractical.

In view of the foregoing it would be advantageous to provide methods for improving the speed of a digital forensic investigation. It would also be advantageous, when imaging a data source, to take into account the relevance of the data being imaged. It would be advantageous to provide apparatus for performing efficient forensic digital investigations. It would also be advantageous, to provide apparatus for performing forensic digital investigations which takes into account the relevance of the data being imaged.

### BRIEF SUMMARY OF THE INVENTION

Many advantages will be determined and are attained by the invention, which in a broadest sense provides apparatus and methods for performing digital forensic investigations. Aspects of the invention provide methods and apparatus which examine a data source of relatively random data, locate relevant data and copy the relevant data and information associated with the relevant data to a storage device using forensically sound techniques, thus converting the random data source into a data source of relevant data. Aspects of the invention provide locating metadata on the data source, analyzing the metadata to locate data that is relevant to an investigation, storing the relevant data onto a storage device along with the associated metadata and creating a hash function to confirm the accuracy and integrity of the storage device. Implementations of the invention may provide one or more of the features disclosed below.

One or more embodiments of the invention provide(s) a method for imaging a data source in forensically sound manner. The method includes a secondary device selectively communicating with the data source; identifying data stored on the data source, wherein the data indicates additional data stored on the data source; parsing the data, analyzing the parsed data to identify the additional data, and copying at least a portion of the additional data to a storage device associated with the secondary device.

One or more embodiments of the invention provide(s) an apparatus for imaging a data source. The apparatus includes at least one connector configured for selectively connecting the apparatus to the data source. It also includes a processor in electrical communication with the connector, and a storage device in electrical communication with the processor. The processor is configured to communicate with the storage device through the connector and identify data located on the data source. The identified data identifies additional data stored on the data source. The processor is also configured to parse the identified data, analyze the parsed data to identify the additional data, and copy at least a portion of the additional data to the storage device.

One or more embodiments of the invention provide(s) a method for imaging a to data source. The method includes a secondary device selectively communicating with the data source. The secondary device identifies data on the data source and the data indicates unused portions of the data source. The secondary device copies a portion of the data source, which is not indicated to be the unused portions, to a storage device.

One or more embodiments of the invention provide(s) a method for imaging a data source in forensically sound manner. The method includes a secondary device selectively communicating with the data source; locating data stored on the data source, wherein the data indicates additional data stored on the data source; parsing the data, analyzing the parsed data to locate the additional data, and copying at least a portion of the additional data to a storage device associated with the secondary device.

The invention will next be described in connection with certain illustrated embodiments and practices. However, it will be clear to those skilled in the art that various modifications, additions and subtractions can be made without departing from the spirit or scope of the claims.

### BRIEF DESCRIPTION OF THE DRAWINGS

For a better understanding of the invention, reference is made to the following description and examples, taken in conjunction with the accompanying drawings, in which like reference characters refer to like parts throughout, and in which:

FIG. 1 is a flow chart of a method of performing a digital forensic investigation in accordance with one or more embodiments of the invention.

FIG. 2 is a diagram of a forensic imaging device in accordance with one or more embodiments of the invention.

The invention will next be described in connection with certain illustrated embodiments, examples and practices. However, it will be clear to those skilled in the art that various modifications, additions, and subtractions can be made without departing from the spirit or scope of the claims.

### DETAILED DESCRIPTION OF THE INVENTION

Apparatus and methods are provided for imaging a digital data source (e.g. computer, computer peripheral, smartphone, video gaming device, video camera, still image camera, network, network device, hard disk, floppy disk, CD, DVD, nonvolatile memory (Flash, USB drive, thumb drive, built-in Flash), volatile memory (RAM) or any other conventional digital storage device) for a digital forensic investigation. Embodiments of the invention create a forensically sound duplicate of relevant data, including the information needed to verify or recreate the duplication, perform low level forensic analysis of the data, recover deleted or slack data, analyze file system metadata and timelines, and other types of digital forensic analysis and store it on a secondary storage device. While the data source can be any digital data source, for ease of explanation the following description will be limited to a computer hard-drive. However, those skilled in the art will recognize that the invention is not so limited and the description may be easily adapted for other devices and understood by those skilled in the art.

A typical data source, such as a computer hard-drive, stores metadata (data that provides information about other data), email files, executable files, document files, unused locations (typically a sequence of binary 0's or bytes for which the file system has no knowledge of their actions) and various other file formats. For purposes herein, a reference to “data” that is identified and/or located may be deemed to refer to metadata and/or a file containing data, whichever is more appropriate for the reference and whichever provides the broader scope for the reference but does not cause the reference to be encompassed by prior art references. Conventional imaging is relatively slow because, among other things, conventional imaging devices attempt to image the entire data source (including, among other things, the unused space). This is inefficient for forensic investigations as it wastes time, storage space and resources copying irrelevant information. An aspect of the invention achieves efficiency over conventional imaging by attempting to limit the imaging to relevant data stored on the data source. For example, if an investigation is only interested in email traffic between two parties, there is no need to store unused space, executable files (e.g. program files), documents, etc. Instead aspects of the invention attempt, in this example, to locate and store email files and the metadata associated with such files while minimizing the amount of irrelevant data such as sequences of binary 0's. This is done by identifying and or locating, accessing and analyzing metadata and using the metadata to find additional data that is relevant to the investigation, then duplicating and storing the metadata and the relevant additional data. It may also or alternatively include parsing a file and learning from the parsed file the location and/or identification of additional data.

Relevance: As previously discussed relevance may be specific to a particular investigation. Thus, criteria for determining forensic relevance may need to be configured for each investigation. Often the criteria may be configurable based on parameters, fields, predicates, mathematical expressions, algebraic expression, file name(s), file path(s), file extension(s) and string regular expressions. For instance, a device or method configured in accordance with one or more embodiments of the invention may be configured to collect data created within certain date ranges, or deleted within certain date ranges, or by certain people, or of a particular type, or in a certain folder. This is especially useful for e-discovery and other legal inquiries. Likewise, such criteria may be combined, using Boolean operators or other means, to form compound criteria, such as Boolean expressions. A device or method configured in accordance with one or more embodiments of the invention may be configured to collect everything except that which is deemed irrelevant. Alternatively, it could be configured to only collect that which is deemed relevant. The difference between these two approaches relates to how items are processed when there is uncertainty about the relevance. Another approach, which may be used in conjunction with one of these other methods is to do cost benefit tradeoffs—e.g. when unsure, collect if size is sufficiently small or collect if the ratio of probability of relevance/size is high enough. Those skilled in the art will recognize that the ratio is not limited to relevance/size but may be any mathematical function of the two and still fall within a scope of the invention. Various conventional sources exist (e.g. written guides to recommended procedures or forensic investigation and analysis) for determining criteria to employ for a particular investigation thus the method for determining criteria will not be discussed further.

Aspects of the invention employ standard relevance criteria, while other aspects use any one of several stored alternate criteria referred to as “profiles”, while still other aspects employ new criteria that can be composed by the investigator. Those skilled in the art will recognize that combinations of these criteria may also be employed. A non-exhaustive list of predicates may include criteria such as:

Was this data block ever used?

Does this data block contain data?

Does this data block contain nonzero data?

Does this data block contain metadata?

Does this data block contain filesystem metadata?

Does this data block belong to a file?

Does this data block belong to a deleted file?

Does the name of the file that this data block belongs equal a particular value?

Does the name of the file that this data block belongs match one value from a set?

Does the name of the file that this data block belongs to contain a particular string?

Does the name of the file that this data block belongs to match a regular expression?

Does the path of the file that this data block belongs equal a particular value?

Does the path of the file that this data block belongs match one value from a set?

Does the path of the file that this data block belongs to contain a particular string?

Does the path of the file that this data block belongs to match a regular expression?

Does the extension of the file that this data block belongs equal a particular value?

Does the extension of the file that this data block belongs match one value from a set?

Does the extension of the file that this data block belongs to contain a particular string?

Does the extension of the file that this data block belongs to match a regular expression?

Does the type of the file that this data block belongs equal a particular value?

Does the type of the file that this data block belongs match one value from a set?

Does the type of the file that this data block belongs to contain a particular string?

Does the type of the file that this data block belongs to match a regular expression?

Does the name of the folder that this data block belongs equal a particular value?

Does the name of the folder that this data block belongs match one value from a set?

Does the name of the folder that this data block belongs to contain a particular string?

Does the name of the folder that this data block belongs to match a regular expression?

Does the path of the folder that this data block belongs equal a particular value?

Does the path of the folder that this data block belongs match one value from a set?

Does the path of the folder that this data block belongs to contain a particular string?

Does the path of the folder that this data block belongs to match a regular expression?

Does the extension of the folder that this data block belongs equal a particular value?

Does the extension of the folder that this data block belongs match one value from a set?

Does the extension of the folder that this data block belongs to contain a particular string?

Does the extension of the folder that this data block belongs to match a regular expression?

Does the type of the folder that this data block belongs equal a particular value?

Does the type of the folder that this data block belongs match one value from a set?

Does the type of the folder that this data block belongs to contain a particular string?

Does the type of the folder that this data block belongs to match a regular expression?

A non-exhaustive list of profiles may include such things as:

Collect all data.

Collect all data except unused data.

Collect data expected to be relevant to investigating digital contraband (e.g. child pornography).

Collect data expected to be relevant to incident response.

Collect data expected to be relevant to e-discovery.

Collect data expected to be relevant to data recovery.

Collect data expected to be relevant to reconstructing activity or events.

Files: Collect all volume and filesystem metadata, and all data belonging to or associated with files that are not deleted. (Does not collect data that does not belong to any file, such as unused data.)

Files+Deletes: Collect all volume and filesystem metadata, and all data belonging to or associated with files, whether or not deleted.

Email: Collect all volume and filesystem metadata, and all data belonging to or associated with email or email files. (This includes data belonging to or associated with common email file formats, such as PST or mbox.)

Internet Activity: Collect all volume and filesystem metadata, and all data belonging to or associated with Internet activity. (This includes data belonging to or associated with files commonly containing browser artifacts, such as history, cookies, stored passwords, and browser cache.)

Digital Contraband: Collect all volume and filesystem metadata, and all data belonging to or associated with user files, both deleted and not deleted. (This does not collect data belonging to system or executable files)

Incident Response: Collect all volume and filesystem metadata, as well as all data belonging to or associated with files that are typically relevant to incident response (investigation of a possible computer break-in). (This includes data belonging to or associated with executables that may be malware, system logs, or recently created, modified, or deleted files.)

Documents and data: Collect all files likely to be documents, or to contain user data.

System or user activity: Collect all files indicative of user or system activity.

Time: Collect all files modified or created in the past N days.

Depending upon the design choice of the system architect, one or more of these predicates and/or profiles may be modified by the investigator and/or one or more may be locked. It is possible that the truth of a particular predicate in a particular case may not be able to be determined with full confidence. In a preferred embodiment, if in doubt the data is collected. Although those skilled will recognize that embodiments may be configured to discard such data. Likewise, in a preferred embodiment, some data will always be collected and stored even if it does not meet the configured criteria. For instance, the initial portions of the data store and of the filesystem are always collected. Filesystem metadata used to locate other data is always collected. Slack space belonging to collected data is always collected. A few sectors of data that are in close proximity to collected data are always collected. Those skilled in the art will recognize that these are design choices and embodiment(s) may be configured not to store some or all of this information, but such choices may affect the usefulness of the imaging process. The following describes aspects of the invention and will be addressed in four main parts: (1) Data Collection, (2) Selective storage, (3) Analysis interface to selective storage and (4) Verification.

Data Collection:

Many data sources have known locations where they store metadata, which can be expected to be relevant. Thus, during data collection metadata is located and temporarily stored (e.g. in a stack, queue, memory, storage, etc.) then analyzed to determine the location of additional relevant data for duplication. Metadata (e.g. Master Boot Record, partition tables, partition maps, disk label, filesystem metadata, File Allocation Table (FAT), FAT Boot Sector, FAT32 FSINFO, directory files, New Technology File System (NTFS) Master File Table (MFT), MFT entries, $MFT File, $MFTMirr file, $Boot file, $Volume file, $Bitmap file, directory indexes, filesystem journals, etc.) are identified/located (e.g. by one or more device level identifiers such as location, sector number, block number, byte number, file path, file name, memory address, URL or any other device level identifier where the device may be queried for the particular identifier) retrieved, parsed and analyzed.

Typically the metadata will provide the location and characteristics of other data (e.g. metadata may identify file name, creation date, file type, data type, whether the file was deleted or not, date of deletion, whether data is part of a file, whether data has been used or is irrelevant, dates of usage, size, encryption, owner, creator, etc.) that is stored on the data source. In those instances, the metadata is analyzed, and from analyzing the metadata, it is determined if the other data is relevant. If the other data is not relevant, the time required to retrieve it may be avoided. Alternatively, the other data is analyzed for relevance (e.g. hashes of data can be computed, and, if they match known good files, such as the National Software Reference Library (NSRL), the data may be deemed irrelevant, etc.) and if it is determined to be relevant, location and other related information is copied to a destination source (e.g. storage device). Additionally, data may be expected to be relevant or irrelevant based on proximity and relationship to other data. For instance, data immediately subsequent to relevant data may be expected to be relevant and data surrounded by irrelevant data may be expected to be irrelevant. Thus, in one or more embodiments, the process may be configured to copy data immediately subsequent to relevant data (although this is merely a design choice). One or more embodiments may sample some of the data, and, based on the sample, expect certain other data to be relevant or irrelevant and will treat it accordingly.

Other times, the metadata or file will provide the location of additional metadata and/or file(s). In those instances, the additional metadata and/or files may be retrieved, parsed and analyzed as was the original metadata/file. This iterative process may continue until no additional metadata/file is located or it may be terminated at a point prior to such time. Those skilled in the art will recognize that the decision when to terminate is a design choice.

Selective Storage:

When the relevant data is identified, duplicated and stored, the location/identifier that the data had in the data source is also stored. This location is stored in metadata which is stored in a manner associated with the copied data. The location or identifier should be sufficient to unambiguously retrieve the data from the storage device. It should also be sufficient to unambiguously assert the state of, at least some of, the device's data and the time of collection. So, in addition to, for example, recording a sector number, it should record that sector's contents, and associate them with that sector number. Typical identifiers include sector number, block number, byte number, or memory address, and depend on the data source. Other identifiers include file path and file name, or URL. Preferably the stored location includes sufficient information to retrieve the data from the storage device without the need for the iterative process performed on the data source. Storing a sector number typically suffices for this purpose in most hard-drives. The location is likewise typically expressed in a format that the storage device can natively and unambiguously retrieve (e.g. sector number). However, the location need not be stored explicitly, as long as sufficient information is stored which allows unambiguously calculating or determining the location. For example, instead of storing a sector number, it may suffice to store a “sector group” number along with the number of sectors which make up one “sector group”; likewise, it may suffice to simply store sector data in a specified order allowing inference of the sector number based on position of that sector's data.

Preferably the duplicated data is stored in the storage device in the same format that it is stored in the data source—or returned by the data source (the data source may store it in one format, but return it over its interface in a different one; depending on design choices, it may make sense to record either one). Each bit provided by the data source is stored, bit for bit. If the data source provides data in blocks, the exact contents of a block are stored—also the information to match those contents with their appropriate block number (i.e. the contents of block X need to be known thus the value of X needs to be known). For instance, if the data source returns a 512 byte sector, the identical sequence of 512 bytes is stored in the storage device. Storing such identical bit-for-bit copies of the data in the form provided by the data store ensures that the duplication is a forensically sound replica, which is repeatable, and subject to low level or device forensic analysis. If the device were to only store the data at the file level, by reassembling the relevant blocks into a file and storing the file, as opposed to the device level, in a manner allowing reconstruction, without ambiguity, of (at least part of) the device's data and state, the forensic quality of the collection would be weakened. While this duplication method is not preferable, it may be useful in certain investigations and thus still falls within a scope of the invention.

Additional information may be stored on the storage device during imaging. For example, the reason the data was deemed relevant, the criteria employed, the commands used to retrieve the data from the data source, the time of retrieval, hash or fingerprints of the data, identification of data not collected, etc. This information could be stored in the same file as the duplicated data or it could be stored separately. Alternatively, some information could be stored with the duplicated data and some information could be stored separately, depending upon the design choice.

Analysis Interface for Selective Storage:

A goal of forensic imaging is to enable collected data to be analyzed, presented, or otherwise read or accessed. Since the image collected and/or stored in accordance with aspects of the invention may be incomplete as compared to the original data source, subsequent data access may need to be modified for the storage device to use partial data. In situations where this is not desirable, the partial data can be presented as complete data using a conventional adapter interface. If the access system tries to access data that has not been collected, the adapter may create an error, indicate that the data was not collected, indicate that the data or data source was bad or corrupt, or return a known dummy value, such as binary zeroes. Likewise, a tool may convert a partial image into a full image, filling in dummy values or indicators of bad data or missing data for locations that were not collected.

Verification of Selective Storage:

Once a conventional forensic image is completed its accuracy may be verified and safety measures may be put into place to ensure that the image is not altered or otherwise tampered with in the future. Typically this involves computing a hash (a relatively short sequence of bits, whose value depends on every bit in the image or the data source) of both the data source and of the image stored on the storage device then comparing the two. If they match then the accuracy of the image is verified. This method works with conventional imaging because conventional imaging duplicates the entire drive. Ensuring that the image is not altered or otherwise tampered with in the future involves calculating a hash of the entire image and securely storing the hash for later verification. The integrity of the image can be verified by recalculating the hash and matching it to the existing hash. If the two match, then the image has not been altered.

Since the image collected and/or stored in accordance with aspects of the invention may be incomplete as compared to the original data source, conventional methods for verifying accuracy may need to be modified accordingly. Options for ensuring the integrity of the image include:
1. Computing the hash over the data that was collected, skipping the parts that were not collected;
2. Computing the hash over the data that was collected, inserting known dummy values (such as sequences of zeroes) in place of data that was not collected; and/or,
3. Providing a list of locations or identifiers of data that were collected or not collected. This list can be stored along with a hash. Alternatively, a hash of this list can be calculated and stored with the image hash.
   As with conventional verification, the hash can be recomputed to verify the integrity of the image. The hash of the original data source can likewise be calculated using any of the above procedures, and compared to the hash of the image to ensure that the image is an accurate copy. Alternatively, conventional piecewise hashing, and other gap tolerant hashing can be used to verify the selective storage.

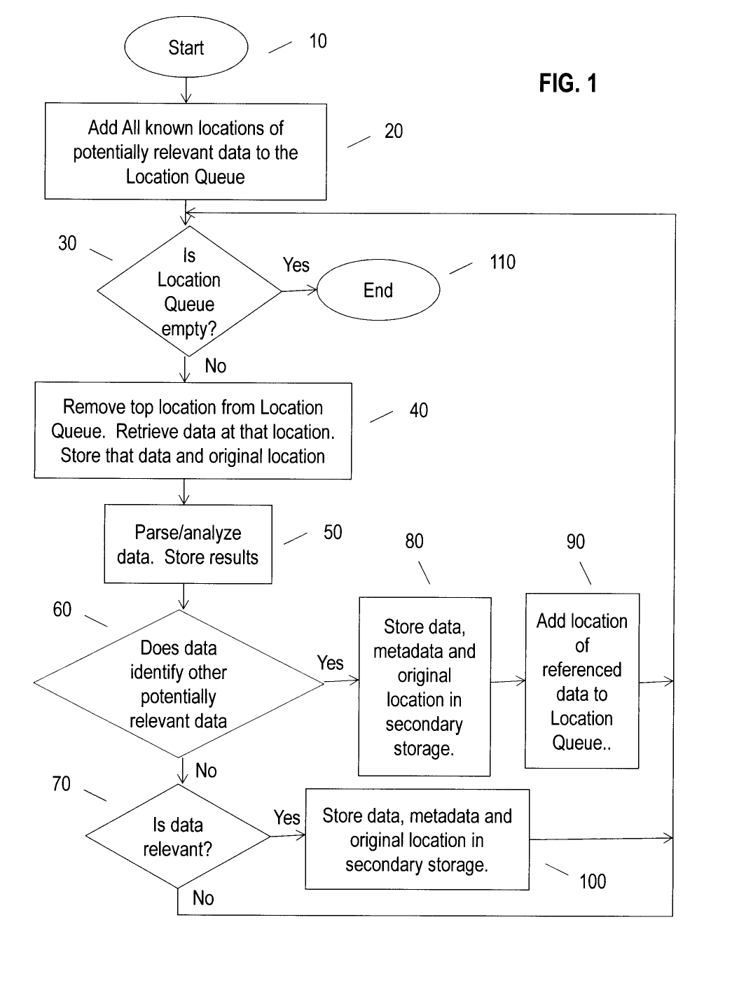

FIG. 1 illustrates a method for performing a forensically sound imaging in accordance with aspects of the invention. Those skilled in the art will recognize that FIG. 1 is an illustration of an embodiment but is not the only possible embodiment for performing methods according to the invention. As illustrated in FIG. 1. The process begins at step 10. At step 20 all known locations of potentially relevant data (e.g. metadata and/or other files) are added to a location queue. At step 30 it is determined in the location queue is empty in which case the process ends 110. If the Location Queue is not empty then at 40 the top (or bottom depending on the format of the queue) location is removed, data is retrieved from that location and that data and its original location is temporarily stored. The data is then parsed/analyzed at 50 (although for reasons of performance, this step may be skipped for certain types of data). If the data identifies additional potentially relevant data 60 then the data and its location is stored in the secondary storage at step 80 and the location of the additional data is added to the Location Queue at 90. If the data does not identify additional potentially relevant data then it is determined if it includes relevant data at step 70. If it does contain relevant data then the data and its location are stored in the secondary storage at step 100. If not relevant then the process returns to step 30.

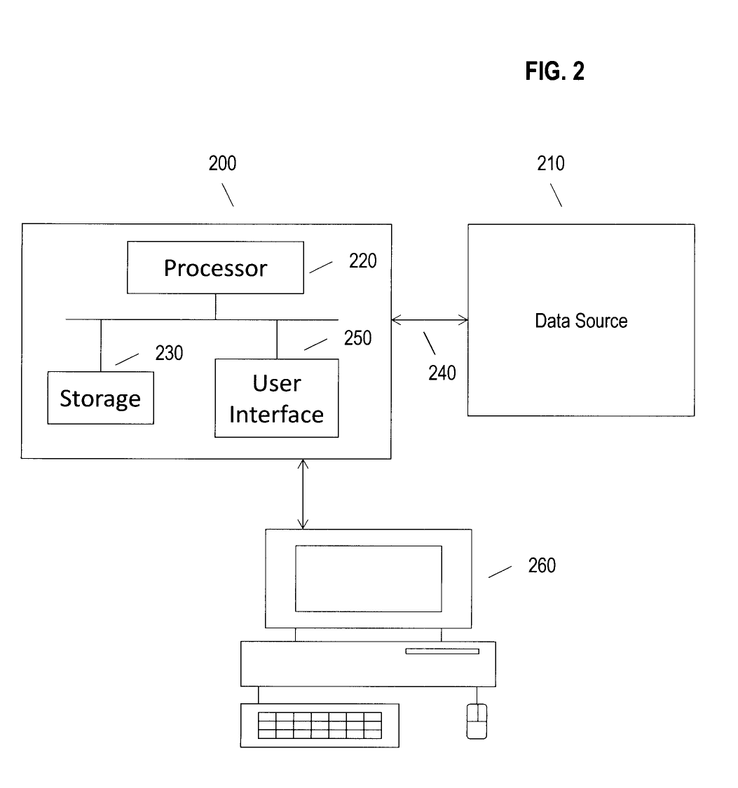

FIG. 2 illustrates an apparatus configured to perform forensically sound imaging in accordance with aspects of the invention. In a preferred embodiment a forensic duplicator, bridge or write blocker 200 is configured to collect and store relevant data from a data source 210 onto a storage device 230. Those skilled in the art will recognize that while FIG. 2 illustrates element 200 connected to computer 260, a forensic duplicator is typically not connected to a computer, while a forensic bridge and write blocker are. However, aspects of the invention may be realized in a software controlled processor on a different device which is connected to the data source via a forensic write blocker with appropriate adapters and connectors, via a network, such as a local area network (LAN), virtual private network (VPN), wide area network (WAN), or the Internet, or via direct hosting of the data source (e.g. downloading software onto the data source or the device controlling the data source and the downloaded software instructing the data source or control device to operate in accordance with aspects of the invention). For ease of explanation the following description will be limited to a modified duplicator 200, however, those skilled in the art will recognize that the description is also applicable to the other embodiments mentioned and one skilled in the art could easily discern from the description how it would apply to other embodiments.

The duplicator 200 may include some or all of the following stored information: the standard location and format of typical volume, partition, and filesystem data and Metadata (including NTFS, FAT, ext2, ext3, ext4, ZFS and other filesystems in use on computers. Data store metadata includes Master Boot Record, partition tables, partition maps, disk label, filesystem metadata, File Allocation Table (FAT), FAT Boot Sector, FAT32 FSINFO, directory files, NTFS Master File Table (MFT), MFT entries, $MFT File, $MFTMirr file, $Boot file, $Volume file, $Bitmap file, directory indexes, filesystem journals, etc.) and instructions for how to parse the same, hashing and sampling methods, and hashes, samples, and summaries of data typically found on data sources; data formats and file formats, including instructions for how to parse and analyze such formats, determine characteristics or location of the data or files, and whether they should be expected to be relevant or not; common investigation or usage scenarios and their typical data of interest; and, the ability to configure or create new scenarios or profiles or definitions of relevant data. Additional location and parsers can be loaded onto the device, using a USB interface.

Aspects of the invention provide a Duplicator 200 which stores the following data structures in volatile memory:

A. location_queue:

Stores one or more sector_numbers in a collection;

Provides add(sector_number) operation, which adds a sector_number to the collection;

If the sector_number already exists in the collection, this has no effect, and the collection is not changed;

Provides pop( ) operation, which removes the numerically lowest sector_number from the collection and returns it;

Typically implemented as a red-black tree of sector numbers.

B. Current_sector_number variable:

A memory space capable of storing one sector number

C. Current_sector_data variable:

A memory space capable of storing the data of exactly one sector.

A sector number along with that sector's data is referred to as a sector_package. The current_sector_number along with the current_sector_data is referred to as the current_sector_package.
D. Retrieved_sectors buffer:

Stores one or more sector_packages (that is, a sector number along with the corresponding sector's data).

Typically implemented as two arrays, the first an array of sector numbers and the second an array of sector data.

One or more embodiments may employ an alternate form of the above data structures, where, instead of storing sector numbers and data at the granularity of individual sectors, pages of multiple sectors are stored together. For instance, a page of 32,768 sectors may be stored together as one unit. In this case, instead of storing the sector number of each sector in a page, it suffices to store the sector number of the first sector in the page. Given any sector number x, it becomes trivial to compute the sector number of the first sector in x's page by simply setting x's 15 least significant bits to zero (if the page size is 32768=2̂15 sectors). This may improve speed in some embodiments, both by reducing the memory required and by retrieving data from the data source more efficiently. Storing entire pages also allows a simpler and more compact storage format, and may be of forensic benefit as well.
D. Autodescription_store: This contains memory to store information about the data source, and its volumes, partitions, filesystems, folders, directories, files, and indexes. This information is typically read and parsed from the data source itself. For a NTFS data source, this will store the sector number of the first sector of the NTFS filesystem; the number of bytes per sector; number of sectors per cluster; number of clusters per MFT entry; first Logical Cluster Number (LCN) of the $MFT; first Logical Cluster Number (LCN) of the $MFTMirr; the sector numbers of the sectors that comprise the Master File Table (MFT), $MFT, $MFT $DATA attribute data, $MFTMirr, and $MFTMirr attribute data; and the sector numbers of the sectors making up each MFT entry. For other types of data sources, similarly appropriate type of information is stored. Descriptions of such information, its location, format, and means of parsing it, is well known and thus will not be described further. Those skilled in the art will recognize that these data structures may be stored elsewhere and still fall within a scope of the invention.

The Duplicator employs the above data structures as follows (FIG. 1):

### 1. START 10

2. Add sectors numbers 0 to 128 to the location_queue 20.
3. Retrieve and remove (“pop”) top sector number from location_queue.

Load sector number into variable current_sector_number.

4. Retrieve from data source data of sector number current_sector_number.

Load this data into current_sector_data variable 40.

5. Add current_{—} sector_{—} number and current_sector_data into a new entry in the retrieved_sectors buffer.
6. Is the current_sector_package a partition table? If so, proceed to step 6a. Otherwise, proceed to step 7.
6a. Parse the partition table, and store the information yielded in the autodescriptive_store.
6b. For each partition in the partition table, add the sector numbers of the first 128 sectors of that partition into the location_queue.
7. Is the current_sector_package a NTFS $Boot sector? If so, proceed to step 7a. Otherwise, proceed to step 8.
7a. Parse the NTFS $Boot sector. Store the information yielded 50, including the number of bytes per sector, number of sectors per cluster, number of clusters per MFT entry, first Logical Cluster Number (LCN) of the $MFT, and first Logical Cluster Number (LCN) of the $MFTMirr, in the autodescriptive_store.
7b. Add the sector numbers of the first 32 MFT entries of the $MFT. (The sector numbers can be calculated using the formula sector_number=first_sector_number_of_ntfs_partition+mft_len+sectors_per_cluster*clusters_per_mft_entry*mft_entry_number).
7c. Add the sector numbers of the first 32 MFT entries of the $MFTMirr. (The sector numbers can be calculated using the formula sector_number=first_sector_number_of_ntfs_partition+mftmirr_lcn+sectors_per_cluster*clusters_per_mft_entry*mft_entry_number).
8. Is the current_sector_package all or part of one of the first 24 MFT entries? If so, proceed to step 8a. Otherwise, proceed to step 9.
8a. Parse the MFT entry. Add the sector numbers of all nonresident data to the location_queue. Proceed to step 10.
9. Is the current_sector_package all or part of any MFT entry? If so, proceed to step 9a. Otherwise, proceed to step 10.
9a. Parse the resident attributes of the MFT entry. If they meet the relevance_criteria (defined below), proceed to step 9b. Otherwise, proceed to step 10.
9b. Parse the MFT entry. Add the sector numbers of all nonresident data to the location_queue. Proceed to step 10.
10. Is queue empty? 30 If yes, proceed to step 11. Otherwise, return to step 3.
11. Write out the entire contents of the retrieved_sectors buffer to the destination storage device (i.e. the media or repository to which the device is duplicating the data source.) This includes, for each sector_package contained in the retrieved_sectors buffer, writing both the sector_data and the sector_number and including a link or association between them.

### 12. END 110

The above embodiment defers step 11 to the end of the algorithm. To improve performance and reduce memory usage, embodiments may instead do this in parallel to or interleave this with the other steps of the algorithm. In other words, as the steps progress, they will write out parts of the retrieved_sectors buffer to the destination store and then free the volatile memory which had contained those sector_packages. The data written out can be stored in any one of a number of formats. Aspects of the invention use a simple format made up of two files, one containing the sector_data of each sector copied in sequence, and one containing the sector_number of each sector copied in sequence. Other aspects of the invention may employ other formats, including standard forensic formats such as EWF, AFF, AFFv3, and AFF4. For embodiments which store the data in AFFv3, pages for which no sectors have been duplicated can simply be to omitted. This obviates the need to explicitly store the sector number; instead, the page number is stored, and sector numbers can be calculated from this page number and the sector's offset within the page. For this to work properly, entire pages of sectors are either collected in their entirety or entirely omitted. For embodiments which store the data in AFF4, it is straightforward to use AFF4's capacity for metadata and mappings to store both a sector's data and sector number, and associate the two. In addition to writing sector data and sector numbers, one or more embodiments of the invention will write out hashes of the data, to support verification later. One or more embodiments of the invention will write out other useful metadata, such as the time of collection, name of investigator, case number, relevance_criteria, etc. For simplicity of illustration, the above shows the steps needed for an NTFS data source. Those skilled in the art can readily adapt the steps to those needed for other data sources, such as FAT, ext2, ext3, ext4, ZFS, HPFS, etc. In pseudocode, the above algorithm can be expressed as:

for i in 0 to 127:
location_queue.add(i)
while (!queue.empty):
current_sector_number = queue.pop( )
current_sector_data = data_source.read(current_sector_number)
current_sector_package.number = current_sector_number
current_sector_package.data = current_sector_data
retrieved_sectors.add(current_sector_package)
if is_partition_table(current_sector_package):
for partition table_entry in parse_partition_table(current_sector_package):
autodescriptive_store.add(partition_table_entry)
for i in 0 to 127:
location_queue.add(partition_table_entry.first_sector + i)
if is_ntfs_boot_sector(current_sector_package):
autodescriptive_store.add(parse_ntfs_boot_sector(current_sector_package))
for i in 0 to 31:
location_queue.add(
autodescriptive_store.get(first_sector_number_of_ntfs_partition) +
autodescriptive_store.get(mft_lcn) +
autodescriptive_store.get(sectors_per_cluster) *
autodescriptive_store.get(clusters_per mft entry) * i)
for i in 0 to 31:
location_queue.add(
autodescriptive_store.get(first_sector_number_of_ntfs_partition) +
autodescriptive_store.get(mftmirr_lcn) +
autodescriptive_store.get(sectors_per_cluster) *
autodescriptive_store.get(clusters_per_mft_entry) * i)
if is_reserved_mft_entry(current_sector_package): # The first 24 MFT entries are
reserved
snums = mft_entry_get_nonresident_sector_numbers(current_sector_package)
for sn in snums:
location_queue.add(sn)
if is_non_reserved_mft_entry(current_sector_package):
resident_attributes = mft_entry_get_resident_attributes(current_sector_package)
if relevance_criteria.match(resident_attributes):
snums = mft_entry_get_nonresident_sector_numbers(current_sector_package)
for sn in snums:
location_queue.add(sn)
copy_to_destination_store(retrieved_sectors)

Instead of using a queue, if the type and nature of references can be assumed to be of a small set with a fixed nature, a fixed procedure may be employed. For instance, the following fixed procedure works for an NTFS filesystem without needing a queue:

0. Initialize a SectorSet to be an empty set.
1. The partition table is at a known location—Collect it.
2. From the partition table, determine the sector of the NTFS $Boot information—Collect it.
3. From the $Boot information, determine the sectors which contain the MFT entries.
4. For each of those sectors:
4a. Collect the sector
4b. For every MFT entry found:
i) Parse the MFT entry
ii) If the entry is deemed relevant AND the entry has non-resident data, determine from the runlist the sector numbers of the non-resident data, and add them to the SectorSet.
   5. Sort the SectorSet (this step is optional)
   6. Collect every sector in the SectorSet.
   Similar procedures can be used for other types of data where the layout is known in advance. This example is simpler to implement than the queue based implementation, but less versatile.

The following is a non-limiting example of the operation of an apparatus in accordance with the invention. The apparatus:
1. Reads known locations of the data source, which typically contain metadata describing the data on the source. For example, the first sector of a hard drive typically contains important metadata describing the data on the drive.
2. Copies and stores the data found in these known locations. For each data stored, the original location of the data in the source is stored as well, and associated with the data.
3. Analyzes the contents of the data at these known locations, and uses it to find the location of other metadata of interest.
4. Reads the data at these other locations.
5. Copies and stores such data. For each data stored, the original location of the data in the source is stored as well, and associated with the data.
6. Analyzes such data to find further metadata, repeating steps 3, 4, 5 and 6 any number of times. For example, the NTFS MFT (Master File Table) may be found, copied, and analyzed accordingly.
7. Analyzes part or all of such discovered metadata to find location and characteristics of other data on the source. For instance, the location of all data belonging to deleted files may be found. Or the location of email data may be found. Or the location of audio video file data may be found. Or, the parts of the data source that have never stored data may be identified.
8. Based on such data and analysis, reads additional data from the source expected to be relevant. For instance, it may read all data expected to be email data.
9. Copies and stores such data. For each data stored, the original location of the data in the source is stored as well, and associated with the data. Alternatively, such data may be further analyzed, and only copied and stored if the analysis indicates it relevant. For instance, it may compute a hash of the data, and if the hash matches known good files on the National Software Reference Library (NSRL), the data may be deemed irrelevant and not copied or stored.
10. Optionally copies and stores other data that is referred to by the data read in the preceding steps. For each data stored, metadata including the original location of the data in the source is stored as well, and associated with the data.
11. Optionally copies and stores other data that is in proximity to the data read in the preceding steps. For instance, it may read, copy, and store all data immediately subsequent to certain identified data. For each data stored, metadata including the original location of the data in the source is stored as well, and associated with the data.

Alternatively or in addition to the above, the apparatus may:
1. Determine which sectors are currently, or ever were, allocated or used by the computer. This can be determined by simply assuming the entire range in between the first known used sector and last known used sector was at one point in use, by examining filesystem metadata, by reversing the operating filesystem's allocation algorithm, by searching, by sampling, or by a combination of these.
2. Add these sector numbers to a queue.
3. (Optional) Remove from the queue any sector numbers which are expected to be forensically irrelevant. The determination of forensic irrelevance is identical to the algorithms listed—that is, read some data, parse it, find references to other data, parse that, etc.—except that instead of looking for forensically relevant data, the device looks for forensically irrelevant data. For instance, filesystem metadata may be employed to determine that certain sectors contain the operating system binary executables, which are typically not relevant to an e-discovery case. These sector numbers may be removed from the queue. Like the definition of relevance, the definition of irrelevance may be variable—it may include only blocks never allocated, or it may include data that is not of interest, etc.
4. Collect and image the sector numbers remaining in the queue.
   This second example will collect more data than the first, thus it is more thorough, but as a result it is also slower.

Still another alternative or addition is to group sectors into pages (e.g. 16 MB sectors), as the AFF format already does, and collecting an entire page when any of its sectors are deemed relevant. Each page is either identical to its counterpart in a traditional image, or completely absent. In general, this selective storage may be implemented by using any format that allows inclusion of the sector number of an individual sector or group of sectors and allows omission of some of these sectors or groups of sectors.

Thus it is seen that apparatus and methods are provided for performing a forensic digital investigation. Although particular embodiments have been disclosed herein in detail, this has been done for purposes of illustration only, and is not intended to be limiting with respect to the scope of the claims, which follow. In particular, it is contemplated by the inventor that various substitutions, alterations, and modifications may be made without departing from the spirit and scope of the invention as defined by the claims. For example, but in no way exhaustive, rather than examining the metadata for relevant data, the metadata can be analyzed to find all unused space and then everything that is not unused space could be duplicated. Another non-exhaustive example is that an operator may manually select data to add to the duplication. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implemented, at least in part, using a computer system, it will be appreciated that a computer program for implementing at least part of the described methods and/or the described apparatus is envisaged as an aspect of the invention. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

Having described the invention, what is claimed as new and secured by Letters Patent is:

1. A method for imaging a data source, the method comprising:
a secondary device selectively communicating with the data source;
said secondary device identifying data stored on said data source, wherein said data indicates additional data stored on said data source;
said secondary device parsing said data;
said secondary device analyzing said parsed data to identify said additional data; and,
said secondary device copying at least a portion of said additional data to a storage device associated with said secondary device.

2. The Method according to claim 1 further comprising storing said identification of said additional data on said storage device.

3. The method according to claim 1 further comprising said secondary device analyzing said parsed data to identify relevant data in said additional data and only copying said relevant data to said storage device.

4. The method according to claim 3 wherein said secondary device determines relevance based on at least one predetermined Boolean expression.

5. The method according to claim 3 wherein said secondary device determines relevance based on a ratio of expected relevance to a size of said additional data.

6. The method according to claim 1 wherein said copying said at least a portion of said additional data is performed at a device level.

7. The method according to claim 1 wherein said copying said at least a portion of said additional data includes copying an identifier associated with said at least a portion of said additional data, said identifier being selected from at least one member of the group consisting of a sector number, a block number, a block address, a byte address, a memory address, a sequence number, a cluster number, a byte number and a device address.

8. The method according to claim 1 wherein said copying said at least a portion of said additional data includes copying an identifier associated with said at least a portion of said additional data, said identifier being sufficient to reconstruct an identifier selected from at least one member of the group consisting of a sector number, a block number, a block address, a byte address, a memory address, a sequence number, a cluster number, a byte number and a device address.

9. The method according to claim 3 further comprising copying data proximal to said additional data and storing said proximal data on said storage device.

10. Apparatus for imaging a data source, the apparatus comprising:
a connector configured for selectively connecting said apparatus to said data source;
a processor in electrical communication with said connector; and,
a storage device in electrical communication with said processor;
said processor being configured to communicate with said storage device through said connector and identify data located on said data source; wherein said identified data identifies additional data stored on said data source;
said processor being further configured to parse said identified data; analyze said parsed data to identify said additional data; and, copy at least a portion of said additional data to said storage device.

11. The apparatus according to claim 10 wherein said processor is further configured to store the identification of said additional data on said storage device.

12. The apparatus according to claim 10 wherein said processor is further configured to analyze said parsed data to identify relevant data in said additional data and copy only said relevant data to said storage device.

13. The apparatus according to claim 12 wherein said processor is configured to determine relevance based on at least one predetermined Boolean expression.

14. The apparatus according to claim 10 wherein said connector is a wireless connector.

15. The apparatus according to claim 10 wherein said connector is a network.

16. The apparatus according to claim 10 wherein said processor is configured to copy said at least a portion of said additional data at a device level.

17. The apparatus according to claim 10 wherein said processor is configured to copy said at least a portion of said additional data by copying an identifier associated with said at least a portion of said additional data, said identifier being selected from at least one member of the group consisting of a sector number, a block number, a block address, a byte address, a memory address, a sequence number, a cluster number, a byte number and a device address.

18. The apparatus according to claim 10 wherein said processor is configured to copy said at least a portion of said additional data by copying an identifier associated with said at least a portion of said additional data, said identifier being sufficient to reconstruct an identifier selected from at least one member of the group consisting of a sector number, a block number, a block address, a byte address, a memory address, a sequence number, a cluster number, a byte number and a device address.

19. The apparatus according to claim 10 further comprising an adapter in electrical communication with said storage device; said adaptor configured to monitor said storage device for an attempt to access data on said storage device;
wherein when the data is stored within said storage device said adapter returns the data; and,
wherein when the data is not stored on said storage device, the adapter returns a response, said response being selected from at least one member of the group of responses consisting of an indication that an error occurred, an indication that the requested data is bad or corrupt, an indication that the request data was not collected or is missing, and predetermined dummy data.

20. The apparatus according to claim 10 further comprising an adapter in electrical communication with said storage device; said adaptor configured to monitor said storage device for an attempt to access data corresponding to data stored at a location on said data source;
wherein when the location is stored within said storage device said adapter returns the corresponding data; and,
wherein when the location is not stored on said storage device, the adapter returns a response, said response being selected from at least one member of the group of responses consisting of an indication that an error occurred, an indication that the requested location is bad or corrupt, an indication that the request location was not collected or is missing, and predetermined dummy data.

21. A method for imaging a data source, the method comprising:
a secondary device selectively communicating with the data source;
said secondary device identifying data on said data source wherein said data enables said secondary device to identify additional portions of said data source; and,
said secondary device copying additional data from said data source, which is not said additional portions, to a storage device.

22. The method according to claim 21 wherein said additional portions include unused portions of the data source.

23. The method according to claim 21 wherein said additional portions include irrelevant data.

24. The Method according to claim 21 further comprising storing an identification of said additional data on said storage device.

25. The method according to claim 21 further comprising said secondary device parsing said data and analyzing said parsed data to identify irrelevant data and only copying data that is not said irrelevant data to said storage device.

26. The method according to claim 21 wherein said copying said additional data is performed at a device level.

27. The method according to claim 21 wherein said copying said additional data includes copying an identifier associated with said additional data, said identifier being selected from at least one member of the group consisting of a sector number, a block number, a block address, a byte address, a memory address, a sequence number, a cluster number, a byte number and a device address.

28. The method according to claim 21 wherein said copying said additional data includes copying an identifier associated with said additional data, said identifier being sufficient to reconstruct an identifier selected from at least one member of the group consisting of a sector number, a block number, a block address, a byte address, a memory address, a sequence number, a cluster number, a byte number and a device address.

29. A method for imaging a data source, the method comprising:
a secondary device selectively communicating with the data source;
said secondary device locating data stored on said data source, wherein said data indicates additional data stored on said data source;
said secondary device parsing said data;
said secondary device analyzing said parsed data to locate said additional data;
said secondary device copying, at a device level, at least a portion of said additional data to a storage device associated with said secondary device; and,
said secondary device computing a hash of said copied data.

30. The method according to claim 29 further comprising said secondary device, prior to computing said hash, inserting known dummy values into said storage device in place of data from said data source that was not stored and then computing said hash on both said copied data and said inserted dummy values.

31. The method according to claim 29 further comprising said secondary device creating a list of identifiers of data that were stored and calculating a hash of said list.

32. The method according to claim 29 further comprising said secondary device creating a list of locations of data that were stored and calculating a hash of said list.

33. The method according to claim 29 further comprising said secondary device creating a list of locations of data that were not stored and calculating a hash of said list.
